(19) United States
(12) Patent Application Publication
(10) Pub. No.: US 2025/0113138 A1
(43) Pub. Date: Apr. 3, 2025

(54) Wideband Sub-Wavelength Chip-Scale Acoustic Wave Attenuators

(71) Applicant: Apple Inc., Cupertino, CA (US)

(72) Inventors: Gokhan Hatipoglu, Milpitas, CA (US); Peter C. Hrudey, San Jose, CA (US); Vahid Naderyan, San Francisco, CA (US)

(21) Appl. No.: 18/765,989

(22) Filed: Jul. 8, 2024

Related U.S. Application Data
(60) Provisional application No. 63/586,746, filed on Sep. 29, 2023.

(51) Int. Cl. H04R 1/10; H04R 3/04

(52) U.S. Cl. CPC H04R 1/1083; H04R 3/04; H04R 2201/003

(57) ABSTRACT

An apparatus comprising: a microelectromechanical systems (MEMS) chip having a movable member coupled to a front chamber; and an attenuator chip coupled to the MEMS chip and having an array of attenuators arranged around a port that is open to the front chamber.

### CROSS-REFERENCE TO RELATED APPLICATION

This application is a non-provisional application of co-pending U.S. Provisional Patent Application No. 63/586,746, filed Sep. 29, 2023 and incorporated herein by reference.

### FIELD

An aspect of the disclosure is directed to wideband sub-wavelength chip-scale attenuators for absorbing ultrasonic acoustic waves within an electronic device. Other aspects are also described and claimed.

### BACKGROUND

Portable communications or listening devices (e.g., smart phones, earphones, etc.) have within them one or more transducers that convert an input electrical audio signal into a sound pressure wave output that can be heard by the user, or a sound pressure wave input into an electrical audio signal. The transducer (e.g., a speaker) can be used to, for example, output sound pressure waves corresponding to the voice of a far end user, such as during a telephone call, or to output sound pressure waves corresponding to sounds associated with a game or music the user wishes to play. Due to the relatively low profile of the portable devices, the transducers also have a relatively low profile, which in turn, can make it difficult to maintain optimal sound quality. In addition, ultrasonic acoustic waves emitted from environmental devices can cause sub-harmonics within the audio bandwidth of the transducer (e.g., a microphone) which are undesirable for system applications. Still further, resonances within a device can amplify the amplitude of ultrasonics, potentially increasing the amplitude of the sub-harmonics.

### SUMMARY

An aspect of the disclosure is directed to an arrangement of attenuators or resonators for absorbing wideband ultrasonic acoustic frequencies within an electronic device. Representatively, ultrasonic acoustic waves emitted from various devices within the environment (e.g., sensors, coffee grinders, cars, etc.) may cause sub-harmonics within the audio bandwidth of a transducer (e.g., a microphone) which are undesirable for system applications such as active noise cancellation (ANC). Moreover, in some cases, the way microelectromechanical systems (MEMS) sensors and actuators are integrated into a device can cause resonances that amplify the amplitude of ultrasonics, increasing the amplitude of the sub-harmonics. Aspects of the disclosure are therefore directed to different arrangements of chip-scale ultrasonic attenuators, integration of the chip-scale attenuators under the MEMS chips of sensors and actuators (e.g., microphones, pressure sensors, IMUs, MEMS speakers, etc.) and other ways of integration within the package. Representatively, in some aspects, the chip-scale ultrasonic attenuators may be formed in a chip or wafer and have necks and cavities whose dimensions are 10× (or more) smaller than the wavelength of interest such that they can act as wideband (20 kHz-1 MHZ) ultrasonic attenuators. For example, the necks may extend into the cavities formed in the chip to maximize the space efficiency. The necks and cavities can form Helmholtz resonators or sub-wavelength attenuators. In some aspects, the chip can contain as many attenuators and of as many shapes and sizes as desired in accordance to dB attenuation and the frequency bandwidth that is targeted. For example, the chip may have a number of chip-scale attenuators with different shaped port openings, different neck and cavity heights, the chips can be stacked aligning the ports of different chips to increase the attenuation efficiency, the necks can be tapered and the ports can have different shape openings (with different number of openings). The shape of the attenuators can be chosen in any shape.

In some aspects, the wideband ultrasonic attenuator array chip can be integrated under the MEMS sensor or actuator element to minimize the chip size and maximize integration. The integration can be achieved via wafer-to-wafer bonding or can be fully part of the front end process flow, so fully becomes part of the MEMS chip. In some aspects, the whole integrated device (e.g., the attenuator chip with the MEMS device chip) can be protected from environmental aggressors (liquid and particle) with another membrane in front of the chip (environmental barrier). It should further be understood that in some aspects, the attenuator chip may have top cap and bottom cap wafers, sandwiching a middle wafer where the attenuators (necks and cavities are formed). A combination of manufacturing techniques may be utilized in some other embodiments, for example, where the bottom cap is removed and only necks are patterned in the middle wafer. Then, the necks are attached to the cavities, which are formed in a package for example and are manufactured with some other manufacturing methods such as PCB processes, LTCC package processes, injection molding, machining, laser cutting etc. In some aspects, there may be vias connecting necks (on the chip) to the cavities (on the sensor/actuator packaging substrate). This configuration achieves wider range of dimensions with different tolerance controls. In further aspects, the chip can be manufactured from MEMS materials including, but not limited to, Silicon, Silicon Nitride, Silicon Carbide as well as polymeric/plastic materials such as PDMS, SU8, etc.

In some aspects, an apparatus is disclosed including a microelectromechanical systems (MEMS) chip having a movable member coupled to a front chamber; and an attenuator chip coupled to the MEMS chip and having an array of attenuators arranged around a port that is open to the front chamber. In some aspects, each attenuator of the array of attenuators comprises a neck having a first open end coupled to the port and a second open end coupled to a cavity formed within the attenuator chip. In still further aspects, the neck and the cavity may have different heights. In some aspects, at least one attenuator of the array of attenuators comprises a different characteristic than another attenuator that is selected to attenuate different ultrasonic frequencies. In some aspects, the different characteristic comprises a length of a neck between the port and a cavity formed within the attenuator chip. In other aspects, the different characteristic may include a shape of a neck between the port and a cavity formed within the attenuator chip. In still further aspects, the different characteristic comprises a volume of a cavity coupled to a neck of the attenuator, or a shape of a cavity coupled to a neck of the attenuator. In some aspects, the attenuator chip includes a first attenuator chip, and a second attenuator chip having an array of attenuators arranged around the port is coupled to the first attenuator chip. The chip may comprise a top cap, a bottom cap and a wafer between the top cap and the bottom cap, and a post between the top cap and the bottom cap. In some aspects, the port includes a number of holes. In still further aspects, the movable member includes a plate operable to move in response to a wave of sound or a pressure change within the front chamber. In other aspects, the MEMS chip comprises an actuator or a sensor. In some aspects, the apparatus further includes a package substrate coupled to the MEMS chip. The package substrate may include a cavity coupled to a neck of at least one attenuator of the array of attenuators. The package substrate may be coupled to a top side of the attenuator chip and a bottom side of the MEMS chip.

In other aspects, an apparatus is disclosed including an attenuator chip comprising: a wafer having a port extending from a top side to a bottom side of the wafer; and an array of attenuators formed within the wafer and arranged around the port. In some aspects, each attenuator of the array of attenuators comprises a neck having a first open end coupled to the port and a second open end coupled to a cavity formed within the wafer. In some aspects, the neck and the cavity have different heights. In still further aspects, at least one attenuator of the array of attenuators comprises a different characteristic than another attenuator that is selected to attenuate different ultrasonic frequencies. The different characteristic may include a length of a neck between the port and a cavity formed within the attenuator chip, a shape of a neck between the port and a cavity formed within the attenuator chip, a volume of a cavity coupled to a neck of the attenuator, and/or a shape of a cavity coupled to a neck of the attenuator. In some aspects, the attenuator chip includes a first attenuator chip, and a second attenuator chip having an array of attenuators arranged around the port is coupled to the first attenuator chip. The attenuator chip may include a top cap, a bottom cap and a wafer between the top cap and the bottom cap, and in some cases, a post between the top cap and the bottom cap. In some aspects, the port comprises a cross shape. In some aspects, the attenuator chip is coupled to a microelectromechanical systems (MEMS) chip having a movable member coupled to a front chamber, and the movable member comprises a plate operable to move in response to a wave of sound or a pressure change within the front chamber.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a cross-sectional side view of one aspect of an assembly having an arrangement of attenuators.

FIG. 2 illustrates a top plan view of an assembly having an arrangement of attenuators.

FIG. 3 illustrates a top plan view of an assembly having an arrangement of attenuators.

FIG. 4 illustrates a top plan view of an assembly having an arrangement of attenuators.

FIG. 5 illustrates a cross-sectional side view of one aspect of an assembly having an arrangement of attenuators.

FIG. 6 illustrates a cross-sectional side view of one aspect of an assembly having an arrangement of attenuators.

FIG. 7 illustrates a cross-sectional side view of one aspect of an assembly having an arrangement of attenuators.

FIG. 8 illustrates a cross-sectional side view of one aspect of an assembly having an arrangement of attenuators.

FIG. 9 illustrates a cross-sectional side view of one aspect of an assembly having an arrangement of attenuators.

FIG. 10 illustrates a cross-sectional side view of one aspect of an assembly having an arrangement of attenuators.

FIG. 11 illustrates a cross-sectional side view of one aspect of an assembly having an arrangement of attenuators.

FIG. 12 illustrates a cross-sectional side view of one aspect of an assembly having an arrangement of attenuators.

FIG. 13 illustrates a block diagram of one aspect of an electronic device within which the array of attenuators of FIG. 1-FIG. 12 may be implemented.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

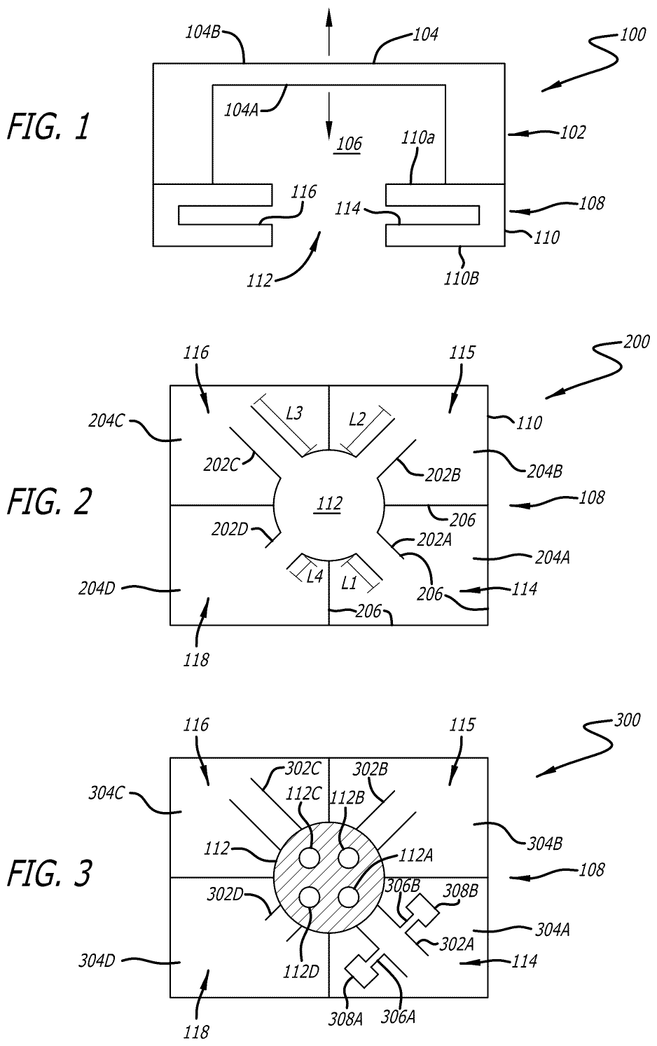

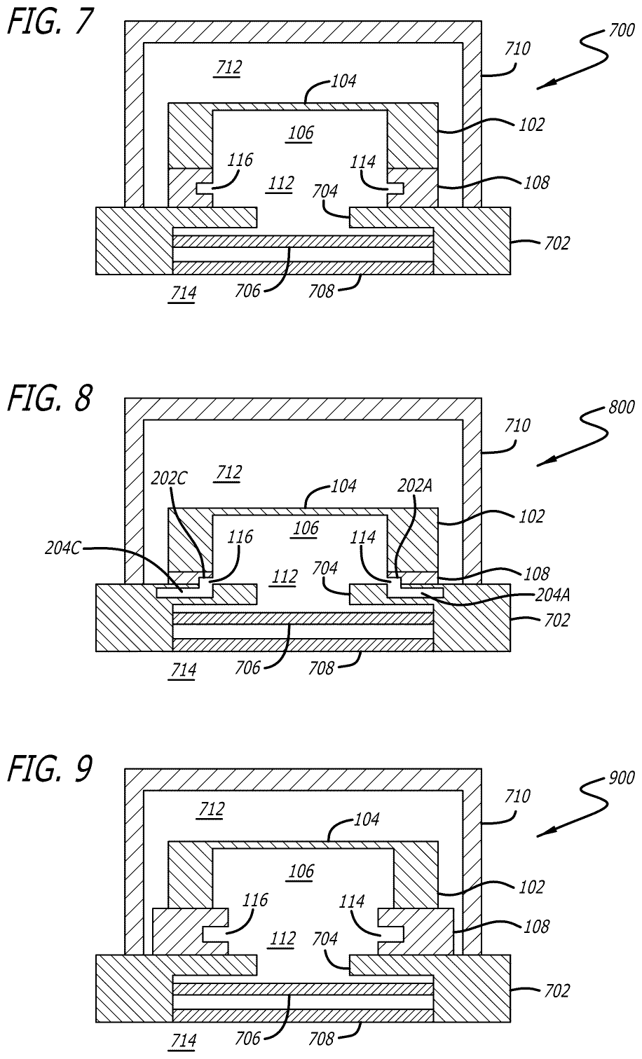

FIG. 1 illustrates a cross-sectional side view of one aspect of a chip scale ultrasonic attenuator assembly. Representatively, in some aspects assembly 100 may include a MEMS chip 102 connected to an attenuator chip 108. MEMS chip 102 may be, for example, a MEMS sensor or actuator as previously discussed. Representatively, MEMS chip 102 may include a movable member 104 and a front chamber 106 formed by the MEMS structure. One side 104A of movable member 104 may define a portion of, or otherwise be considered open to, front chamber 106. Front chamber 106 may be open to the ambient environment through, for example a port within an enclosure containing assembly 100. In this aspect, changes in the ambient environment may cause movable member 104 to move or vibrate as illustrated by the arrows. For example, movable member 104 may be, for example, a membrane or plate that is movable in response to an incoming sound wave, pressure change, or other change within front chamber 106. Representatively, MEMS chip 102 may be a MEMS transducer such as a microphone and movable member 104 may vibrate or move in response to an incoming sound wave. It may further be understood that another side 104B of moveable member may define a portion of, or otherwise be considered open to, another chamber, for example a closed back volume chamber. The back volume chamber may be formed along the other side 104B of member 104 by an enclosure, package or electronic device within which chip 102 is integrated. These aspects, including the integration of assembly 100 within an enclosure, package or electronic device, will be described in more detail in reference to FIGS. 7-12.

Referring now in more detail to attenuator chip 108, attenuator chip 108 may include, for example, a wafer 110 of semiconductor material that can be used for the fabrication of integrated circuits. In some aspects, a top side 110A of wafer 110 may be connected or otherwise attached to MEMS chip 102. Wafer 108 may include a pathway, passage, or port 112 that extends entirely through wafer 108 (e.g., from top side 110A to bottom side 110B) and is aligned with, and open to, chamber 106 of MEMS chip 102. A number of attenuators 114, 116 may further be formed within wafer 108. Attenuators 114, 116 may be open to, and arranged around, port 112 as shown. Representatively, attenuators 114, 116 may be Helmholtz resonators that are open at one end to port 112 and extend from port 112 to an enclosed volume of air or cavity formed within wafer 108. In other aspects, attenuators 114, 116 may be sub-wavelength (e.g., half, quarter) tubes that are open to port 108 at one end and closed at the other end. Attenuators 114, 116 may have different sizes, shapes and/or characteristics selected to attenuate different ultrasonic frequencies passing through port 112 such that attenuator chip 102 may act as a wideband (30-1 MHZ) ultrasonic attenuator. It should further be understood that while two attenuators 114, 116 can be seen in this view, any number of attenuators are contemplated. In addition, attenuators 114, 116 may be formed entirely within a single wafer 108 such that attenuator chip 108 is considered a chip scale attenuator. This is in contrast to, for example, an attenuator formed by, or otherwise within, a substrate of, for example, a printed circuit board (PCB).

Referring now to FIGS. 2-4, FIGS. 2-4 illustrate top plan views of different attenuator chip configurations for attenuating wideband ultrasonic frequencies. FIG. 2 illustrates an attenuator chip assembly 200 including a chip scale ultrasonic attenuator 108 formed by a wafer 110 having a number of attenuators 114, 115, 116, 118. Wafer 108 includes a port 112 as previously discussed, and attenuators 114, 115, 116, 118 are arranged around, and connected to, port 112. From this view, it can be seen that each of attenuators 114-118 include a neck portion that extends to a cavity portion formed within wafer 110. Representatively, attenuator 114 may include a neck portion 202A that is open at one end to port 112 and open at the other end to cavity 204A. Neck portion 202A may be formed by interior side walls and have a characteristic selected to attenuate a desired frequency (e.g., an ultrasonic frequency). Representatively, neck portion 202A may have a length dimension (L1) that is selected or otherwise tuned to attenuate the desired frequency (e.g., an ultrasonic frequency range of 20 kHz-1 MHZ). In some aspects, neck portion 202A may have a different length (L1) than any other neck portion such that it attenuates a different frequency than the other attenuators. Cavity 204A is formed within a portion of wafer 110. Cavity 204A shares a volume with neck portion 202A but is otherwise closed off and does not share a volume with any other cavities. For example, cavity 204A may be formed by a number of interior and exterior sidewalls 206 that extend from the top side to the bottom side (e.g., top side 110A to bottom side 110B) of wafer 110 to divide wafer 110 into a number of cavities. Neck portion 202A and cavity 204A may have a shape, size and/or volume selected to attenuate the desired frequency. For example, in some aspects neck portion 202A and cavity 204A can have a number of shapes and sizes including spirals, rectangles, squares, circles or the like. In addition, neck portion 202A may extend into cavity 204A as shown to maximize the space efficiency. Attenuators 115, 116, 118 may be similar to attenuator 114 and include neck portions 202B, 202C, 202D that extend from port 112 to cavities 204B, 204C, 204D, respectively. Attenuators 115, 116, 118 may have a characteristic selected to attenuate a desired ultrasonic frequency, that may be different than each other and that of attenuator 114. For example, each of neck portions 202B, 202C, 202D may have a different length dimension than each other and neck portion 202A that is selected to attenuate different frequencies (e.g., a wideband of different ultrasonic frequencies). Representatively, neck portion 202B may have a length (L2), neck 202C may have a length (L3) and neck 202D may have a length (L4). In some aspects, a size of the length dimensions may be L4 may be smaller than L1, which may be smaller than L2, which may be smaller than L3, as shown. Neck portions 202B-D may, however, have a same shape as each other and neck portion 202A. Neck portions 202B, 202C, 202D may extend to cavities 204B, 204C and 204D, respectively, formed within wafer 110. Cavities 204B-D may be formed by sidewalls 206 and have a similar shape and size to that of cavity 204A, as previously discussed. In addition, it should be understood that while four attenuators 114, 115, 116, 118 are illustrated, it is contemplated that more attenuators may be included depending on the frequency range of attenuation desired. Representatively,

Referring now to FIG. 3, FIG. 3 illustrates an attenuator chip assembly 300 including a chip scale ultrasonic attenuator 108 formed by a wafer 110 having a number of attenuators 114, 115, 116, 118. Wafer 108 includes a port 112, and attenuators 114, 115, 116, 118 are arranged around, and connected to, port 112, as previously discussed. Each of attenuators 114-118 include a neck portion 302A-D that extends to a cavity portion 304A-D formed within wafer 110, as previously discussed. Each of neck portions 302A-D may have a different characteristic selected to attenuate a desired frequency. In this configuration, however, the different characteristic may be a shape of the neck portions 302A-D. Representatively, neck portions 302B and 302C of attenuators 115 and 116, respectively, may have a tapered or horn shape. For example, neck portion 302B of attenuator 115 may be formed by sidewalls which are closer together at the end connected to port 112 and become farther apart at the end connected to cavity 304B. Neck portion 302C of attenuator 116, on the other hand, may be formed by sidewalls which are farther apart at the end connected to port 112 and become closer together at the end connected to cavity 304C. Neck portions 302B and 302C may have a substantially same length as shown, or could have different lengths. Referring now to attenuator 118, attenuator 118 may have a neck portion 302D with substantially parallel sides and that extends to cavity portion 304D, similar to the previously discussed attenuator 118. Attenuator 114 may have a neck portion 302A with a different characteristic than neck portions 302B-D. Representatively, neck portion 302A may be formed by substantially parallel sides that are longer than neck portion 302A and extend to cavity 304A. In this configuration, however, neck portion 302A includes interior attenuators that branch off of neck portion 302A. Representatively, interior neck portions 306A, 306B branch off the side walls of neck portion 302A and extend to interior cavities 308A, 308B, as shown. For example, interior neck portions 306A, 306B may have an open end that connects to openings in the side walls of neck portion 302A, and another open end that connects to interior cavities 308A, 308B. Interior cavities 308A, 308B may be substantially closed cavities that are isolated, or otherwise separated from, cavity 114. The shape, size and dimensions of neck portions 306A-B and cavities 308A-B may be further selected to attenuate a desired frequency range. It should further be understood that while two interior attenuators are shown, more or less interior attenuators are contemplated depending on the frequency attenuation desired.

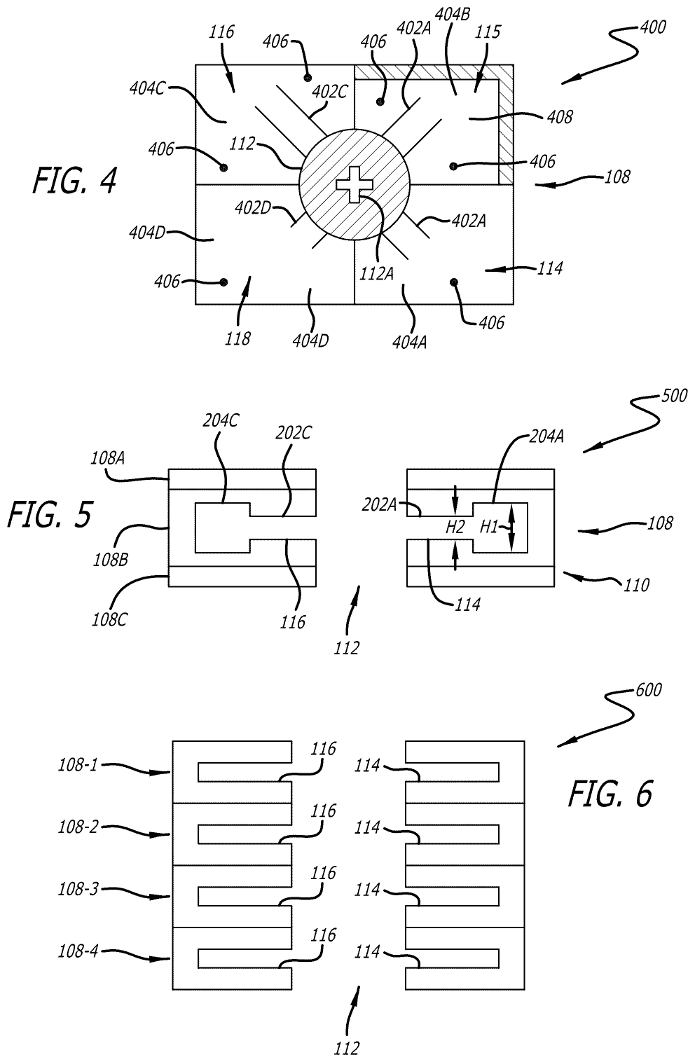

It can further be understood from this view that port 112 may include a number of openings 112A, 112B, 112C and 112D. The number of openings 112A-D may be formed through wafer 110 and/or through a membrane or other layer or structure positioned over opening 112. For example, in some aspects, a thin layer of another material (e.g., a material layer having a thickness of 25 microns to 1 mm) may be formed over port 112 and the openings 112A-D formed through the layer of material. In this aspect, openings 112A-D open to a larger single port 112. The number of openings 112A-D and their sizes and/or shapes may be selected to provide a number of additional advantages to attenuator chip 108. Representatively, a number of different opening 112A-D configurations may be selected to achieve particle robustness, prevent liquid and/or particle ingress and/or mechanical and acoustical tuning. For example, FIG. 3 illustrates a port configuration including four round openings 112A-D. It is contemplated, however, that the openings 112A-D may have different sizes and shapes, for example, rectangular, square elliptical, or other sizes and shapes. In addition, port 112 may be formed by more or fewer openings 112A-D. For example, in some aspects, port 112 may be formed by two rectangular openings that extend through wafer 110 or a membrane or layer attached to a single larger port 112. In other aspects, port 112 may be formed by a single opening 112A having a cross-like shape as shown in FIG. 4.

Referring now to FIG. 4, FIG. 4 illustrates an attenuator chip assembly 400 including a chip scale ultrasonic attenuator 108 formed by a wafer 110 having a number of attenuators 114, 115, 116, 118. Wafer 110 includes a port 112, and attenuators 114, 115, 116, 118 are arranged around, and connected to, port 112, as previously discussed. Each of attenuators 114-118 include a neck portion 402A-D that extends to a cavity portion 404A-D formed within wafer 110, as previously discussed. In this configuration, however, each of neck portions 402A-D may have a same size and shape, and at least one of cavities 404A-D may have a different characteristic selected to attenuate a different frequency. Representatively, cavity 404B may have a smaller volume than the other cavities 404A, 404C, 404D. For example, the exterior side wall 408 forming cavity 404B may be thicker than the side walls forming the other cavities 404A, 404C and 404D such that it reduces the volume of cavity 404B. In other aspects, the volume of cavity 404B may be reduced by decreasing the height or another dimension of cavity 404B. In addition, it can be seen from this view that port 112 may have a cross-like shape 112A as previously discussed. In still further aspects, support posts 406 between the top and bottom sides (e.g., top and bottom sides 110A, 110B) may be formed in each of cavities 404A-D. Support posts 406 may be sized and dimensioned to reinforce or otherwise increase the robustness of cavities 404A-D.

Referring now to FIG. 5, FIG. 5 illustrates a cross-sectional side view of an attenuator chip assembly 500 including a chip scale ultrasonic attenuator 108 formed by a wafer 110 having a number of attenuators 114, 116. Wafer 110 includes a port 112, and attenuators 114, 116 are arranged around, and connected to, port 112, as previously discussed. Each of attenuators 114, 116 include a neck portion 202A, 202C that extends to a cavity portion 204A, 204C formed within wafer 110, as previously discussed. Each of attenuators 114, 116 may have a different characteristic selected to attenuate different frequencies. For example, in this configuration, neck portions 202A and 202C may have a different depth or z-height than cavities 204A and 204C. Representatively, cavities 204A, 204C may have a first height (H1) and neck portions 202A, 202C may have a second height (H2). In some aspects, height (H1) of cavities 204A, 204C may be greater than the height (H2) of neck portions 202A, 202C. In other aspects, height (H1) of cavities 204A, 204B may be less than the height (H2) of neck portions 202A, 202C. In addition, in still further aspects, cavities 204A and 204C may have different heights and/or neck portions 202A and 202C may have different heights. The heights (H1), (H2) of neck portions 202A, 202C and/or cavities 204A, 204C may be selected or otherwise tuned so that attenuators 114, 116 can attenuate different ultrasonic frequencies.

Referring now to FIG. 6, FIG. 6 illustrates a cross-sectional side view of an attenuator chip assembly 600 including a stack up of attenuator chips 108-1, 108-2, 108-3, 108-4 formed by a wafer 110 having a number of attenuators 114, 116. Each wafer 110 includes a port 112, and attenuators 114, 116 are arranged around, and connected to, port 112, as previously discussed. Each of attenuators 114, 116 include a neck portion and a cavity portion formed within wafer 110. The attenuators 114, 116 within each of wafers 110 may have different characteristics (e.g., size, shape, volume, etc.) selected to attenuate wideband ultrasonic frequencies, as previously discussed. In addition, by stacking more than one chip scale ultrasonic attenuator (e.g., attenuators 108-1, 108-2, 108-3, 108-4) a larger magnitude of attenuation may be achieved. It should further be understood that while four attenuator chips 108-1, 108-2, 108-3 and 108-4 are shown in a stack up, it is contemplated that more or less attenuator chips 108-1, 108-2, 108-3 and 108-4 may be included in the stack up.

Referring now to FIGS. 7-12, FIGS. 7-12 illustrates a package, device or other assembly with the previously discussed attenuator and MEMS chip assemblies integrated therein. Representatively, FIG. 7 illustrates an assembly 700 including MEMS chip 102 attached to an attenuator chip 108 having attenuators 114, 116 formed therein, as previously discussed. Attenuator chip 108 may be considered to be fully a part of MEMS chip 102 in that they are directly bonded, or otherwise attached, to one another. In addition, in the illustrated configuration, port 112 of attenuator chip 108 may have a substantially similar width or opening size as front chamber 106. Attenuator chip 108 is further connected, attached or otherwise mounted to a printed circuit board (PCB) or other substrate 702. Substrate 702 defines an opening 704 that is aligned with the port 112 of attenuator chip 108. Opening 704 may be formed entirely through substrate 702 and connect front chamber 106 of MEMS chip 102 to the ambient environment 714. In some aspects, opening 704 may be a different size than port 112 of attenuator chip 108 and be considered an acoustic opening that allows sound waves from ambient environment 714 to pass through it and impinge upon the movable member 104 of MEMS chip 102. In some aspects, opening 704 may optionally be covered by membranes or mesh layers 706, 708. Layer 706 may, in some aspects, be a membrane such as an environmental barrier that protects the interior components, for example, from particle ingress. Layer 708 may, in some aspects, be a mesh that may be acoustically transparent and/or tune desired acoustic characteristics of assembly 700. A housing or enclosure 710 is further positioned around MEMS chip 102 and attenuator chip 108 and attached to substrate 702 to enclosure the electronic components. In this aspect, housing or enclosure 710 may be understood as forming a chamber 712 around MEMS chip 102 and attenuator chip 108. In some aspects, chamber 712 may be isolated, or otherwise separated from, the front chamber 106 and ambient environment 714. In some aspects, chamber 712 may be considered a back volume chamber. It should further be understood that in some aspects, attenuator chip 108 may include electronic circuitry and/or trace patterns be formed by standard MEMS processing techniques, and which may be connected to electronic circuitry or trace patterns of substrate 702 formed by other manufacturing techniques. In this aspect, a wider range of dimensions, different tolerance controls, thinner attenuator chip dimensions may be achieved.

Referring now to FIG. 8, FIG. 8 illustrates an assembly 800 including MEMS chip 102 attached to an attenuator chip 108 having attenuators 114, 116 formed therein, as previously discussed. Attenuator chip 108 may be considered to be fully a part of MEMS chip 102 in that they are directly bonded, or otherwise attached, to one another. Attenuator chip 108 is further connected, attached or otherwise mounted to a printed circuit board (PCB) or other substrate 702. Substrate 702 defines an opening 704 that is aligned with the port 112 of attenuator chip 108. Opening 704 may be formed entirely through substrate 702 and connect front chamber 106 of MEMS chip 102 to the ambient environment 714, as previously discussed. In addition, opening 704 may optionally be covered by membranes or mesh layers 706, 708 that provide an environmental barrier and/or acoustic enhancements to assembly 800. A housing or enclosure 710 is further positioned around MEMS chip 102 and attenuator chip 108 and attached to substrate 702 to enclosure the electronic components, as previously discussed. In this configuration, however, attenuators 114, 116 may be formed by a combination of attenuator chip 108 and substrate 702. For example, in some aspects, neck portions 202A, 202C may be formed in the wafer of chip 108. The cavities 204A, 204C, however, may be formed within substrate 702 as shown. In this aspect, neck portions 202A, 202C may be considered to be within a different plane than cavities 204A, 204C. In this aspect, neck portions 202A, 202C may have an L or other bent type of shape such that they are open at one end to port 112 connected to chamber 106, and at the other end to cavities 204A, 204C formed in the substrate below chip 108. Similar to any of the previously discussed attenuator chip configurations, the neck portions or cavities of attenuators 114, 116 may have different characteristics tuned or selected to attenuate a desired range of ultrasonic frequencies.

Referring now to FIG. 9, FIG. 9 illustrates an assembly 900 including MEMS chip 102 attached to an attenuator chip 108 having attenuators 114, 116 formed therein, as previously discussed in reference to FIG. 7. In this configuration, however, port 112 of attenuator chip 108 may have a smaller width or opening size than front chamber 106. In some aspects, attenuator chip 108 may be a separate chip that is placed underneath and bonded to MEMS chip 102 during separate processing operations. Attenuator chip 108 is further connected, attached or otherwise mounted to, a printed circuit board (PCB) or other substrate 702. Substrate 702 defines an opening 704 that is aligned with the port 112 of attenuator chip 108. Opening 704 may be formed entirely through substrate 702 and connect front chamber 106 of MEMS chip 102 to the ambient environment 714, as previously discussed. In addition, opening 704 may optionally be covered by membranes or mesh layers 706, 708 that provide an environmental barrier and/or acoustic enhancements to assembly 900. A housing or enclosure 710 is further positioned around MEMS chip 102 and attenuator chip 108 and attached to substrate 702 to enclosure the electronic components, as previously discussed. Similar to any of the previously discussed attenuator chip configurations, the neck portions or cavities of attenuators 114, 116 may have different characteristics tuned or selected to attenuate a desired range of ultrasonic frequencies.

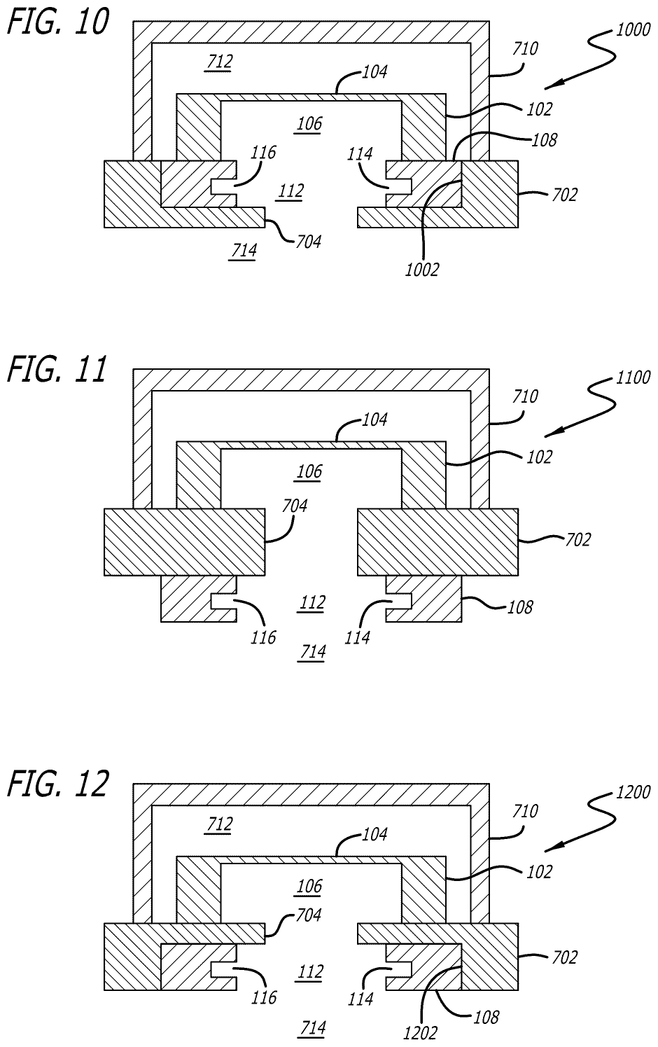

Referring now to FIG. 10, FIG. 10 illustrates an assembly 1000 including MEMS chip 102 attached to an attenuator chip 108 having attenuators 114, 116 formed therein, as previously discussed in reference to FIG. 9. In some aspects, attenuator chip 108 may be a separate chip that is placed underneath and bonded to MEMS chip 102 during separate processing operations. Attenuator chip 108 is further connected, attached or otherwise mounted to, a printed circuit board (PCB) or other substrate 702, as previously discussed. In this configuration, however, attenuator chip 108 is embedded within a recessed region 1002 formed within substrate 702. Representatively, substrate 702 defines a recessed region 1002 dimensioned to contain attenuator chip 108 and opening 704 below recessed region 1002 and chip 108, that is aligned with the port 112 of attenuator chip 108. Opening 704 may be formed entirely through the portion of substrate 702 below chip 108 and connect front chamber 106 of MEMS chip 102 to the ambient environment 714, as previously discussed. In addition, although not shown, opening 704 may optionally be covered by membranes or mesh layers as previously discussed. A housing or enclosure 710 is further positioned around MEMS chip 102 and attenuator chip 108 and attached to substrate 702 to enclosure the electronic components, as previously discussed. Similar to any of the previously discussed attenuator chip configurations, the neck portions or cavities of attenuators 114, 116 may have different characteristics tuned or selected to attenuate a desired range of ultrasonic frequencies.

Referring now to FIG. 11, FIG. 11 illustrates an assembly 1100 including MEMS chip 102 attached to an attenuator chip 108 having attenuators 114, 116 formed therein, as previously discussed. In this configuration, however, substrate 702 is attached (e.g., bonded) directly to the bottom side of MEMS chip 102 and attenuator chip 108 is a separate chip that is placed underneath and bonded to a bottom of substrate 702. Port 112 of attenuator chip 108 is aligned with opening 704 formed entirely through substrate 702 to connect front chamber 106 of MEMS chip 102 to the ambient environment 714, as previously discussed. In addition, although not shown, opening 704 may optionally be covered by membranes or mesh layers as previously discussed. A housing or enclosure 710 is further positioned around MEMS chip 102 and attenuator chip 108 and attached to substrate 702 to enclosure the electronic components, as previously discussed. Similar to any of the previously discussed attenuator chip configurations, the neck portions or cavities of attenuators 114, 116 may have different characteristics tuned or selected to attenuate a desired range of ultrasonic frequencies.

Referring now to FIG. 12, FIG. 12 illustrates an assembly 1200 including MEMS chip 102 attached to an attenuator chip 108 having attenuators 114, 116 formed therein, as previously discussed. In this configuration, similar to FIG. 11, substrate 702 is attached (e.g., bonded) directly to the bottom side of MEMS chip 102 and attenuator chip 108 is a separate chip that is placed underneath and bonded to a bottom of substrate 702. In this configuration, however, attenuator chip 108 is embedded within a recessed region 1202 formed in the bottom side of substrate 702. Representatively, substrate 702 defines a recessed region 1202 along its bottom side dimensioned to contain attenuator chip 108. Opening 704 of substrate 702 formed above recessed region 1002 and chip 108 is aligned with the port 112 of attenuator chip 108. In this aspect, opening 704 connects front chamber 106 of MEMS chip 102 to the ambient environment 714, as previously discussed. In addition, although not shown, opening 704 may optionally be covered by membranes or mesh layers as previously discussed. A housing or enclosure 710 is further positioned around MEMS chip 102 and attenuator chip 108 and attached to substrate 702 to enclosure the electronic components, as previously discussed. Similar to any of the previously discussed attenuator chip configurations, the neck portions or cavities of attenuators 114, 116 may have different characteristics tuned or selected to attenuate a desired range of ultrasonic frequencies.

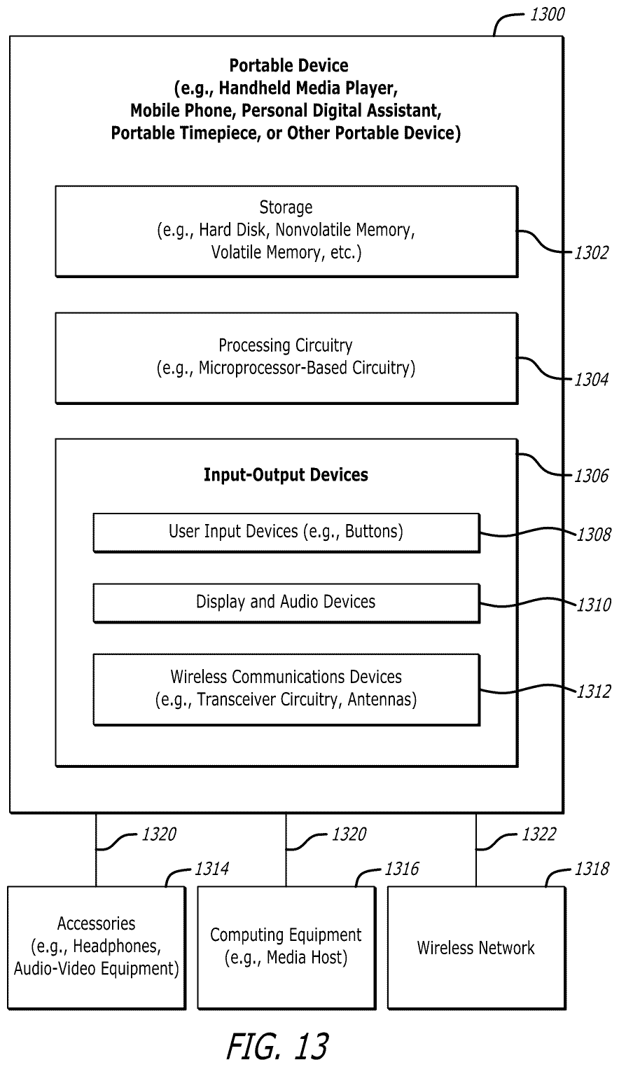

Referring now to FIG. 13, FIG. 13 illustrates a block diagram of one aspect of an electronic device within which the previously discussed speaker may be implemented. As shown in FIG. 13, device 1300 may include storage 1302. Storage 1302 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 1304 may be used to control the operation of device 1300. Processing circuitry 1304 may be based on a processor such as a microprocessor and other suitable integrated circuits. With one suitable arrangement, processing circuitry 1304 and storage 1302 are used to run software on device 1300, such as internet browsing applications, voice-over-internet-protocol (VOIP) telephone call applications, email applications, media playback applications, operating system functions, etc. Processing circuitry 1304 and storage 1302 may be used in implementing suitable communications protocols. Communications protocols that may be implemented using processing circuitry 1304 and storage 1302 include internet protocols, wireless local area network protocols (e.g., IEEE 802.11 protocols—sometimes referred to as Wi-Fi®), protocols for other short-range wireless communications links such as the Bluetooth® protocol, protocols for handling 3G or 4G communications services (e.g., using wide band code division multiple access techniques), 2G cellular telephone communications protocols, etc.

To minimize power consumption, processing circuitry 1304 may include power management circuitry to implement power management functions. For example, processing circuitry 1304 may be used to adjust the gain settings of amplifiers (e.g., radio-frequency power amplifier circuitry) on device 1300. Processing circuitry 1304 may also be used to adjust the power supply voltages that are provided to portions of the circuitry on device 1300. For example, higher direct-current (DC) power supply voltages may be supplied to active circuits and lower DC power supply voltages may be supplied to circuits that are less active or that are inactive. If desired, processing circuitry 1304 may be used to implement a control scheme in which the power amplifier circuitry is adjusted to accommodate transmission power level requests received from a wireless network.

Input-output devices 1306 may be used to allow data to be supplied to device 1300 and to allow data to be provided from device 1300 to external devices. Display screens, microphone acoustic ports, speaker acoustic ports, and docking ports are examples of input-output devices 1306. For example, input-output devices 1306 can include user input-output devices 1308 such as buttons, touch screens, joysticks, click wheels, scrolling wheels, touch pads, key pads, keyboards, microphones, cameras, etc. A user can control the operation of device 1300 by supplying commands through user input devices 1308. Display and audio devices 1310 may include liquid-crystal display (LCD) screens or other screens, light-emitting diodes (LEDs), and other components that present visual information and status data. Display and audio devices 1310 may also include audio equipment such as speakers and other devices for creating sound. Display and audio devices 1310 may contain audio-video interface equipment such as jacks and other connectors for external headphones and monitors.

Wireless communications devices 1312 may include communications circuitry such as radio-frequency (RF) transceiver circuitry formed from one or more integrated circuits, power amplifier circuitry, passive RF components, antennas, and other circuitry for handling RF wireless signals. Wireless signals can also be sent using light (e.g., using infrared communications). Representatively, in the case of a speaker acoustic port, the speaker may be associated with the port and be in communication with an RF antenna for transmission of signals from the far end user to the speaker.

Returning to FIG. 13, device 1300 can communicate with external devices such as accessories 1314, computing equipment 1316, and wireless network 1318 as shown by paths 1320 and 1322. Paths 1320 may include wired and wireless paths. Path 1322 may be a wireless path. Accessories 1314 may include headphones (e.g., a wireless cellular headset or audio headphones) and audio-video equipment (e.g., wireless speakers, a game controller, or other equipment that receives and plays audio and video content), a peripheral such as a wireless printer or camera, etc.

Computing equipment 1316 may be any suitable computer. With one suitable arrangement, computing equipment 1316 is a computer that has an associated wireless access point (router) or an internal or external wireless card that establishes a wireless connection with device 1300. The computer may be a server (e.g., an internet server), a local area network computer with or without internet access, a user's own personal computer, a peer device (e.g., another portable electronic device), or any other suitable computing equipment.

Wireless network 1318 may include any suitable network equipment, such as cellular telephone base stations, cellular towers, wireless data networks, computers associated with wireless networks, etc. For example, wireless network 1318 may include network management equipment that monitors the wireless signal strength of the wireless handsets (cellular telephones, handheld computing devices, etc.) that are in communication with network 1318.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. For example, although a speaker is specifically disclosed herein, the attenuators disclosed herein could be used with other types of transducers, for example, microphones. Still further, although a portable electronic device such as a mobile communications device is described herein, any of the previously discussed attenuator and transducer configurations may be implemented within a tablet computer, personal computer, laptop computer, notebook computer, headphones and the like. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. An apparatus comprising:
a microelectromechanical systems (MEMS) chip having a movable member coupled to a front chamber; and
an attenuator chip coupled to the MEMS chip and having an array of attenuators arranged around a port that is open to the front chamber.

2. The apparatus of claim 1 wherein each attenuator of the array of attenuators comprises a neck having a first open end coupled to the port and a second open end coupled to a cavity formed within the attenuator chip.

3. The apparatus of claim 2 wherein the neck and the cavity have different heights.

4. The apparatus of claim 1 wherein at least one attenuator of the array of attenuators comprises a different characteristic than another attenuator that is selected to attenuate different ultrasonic frequencies.

5. The apparatus of claim 4 wherein the different characteristic comprises a length of a neck between the port and a cavity formed within the attenuator chip.

6. The apparatus of claim 4 wherein the different characteristic comprises a shape of a neck between the port and a cavity formed within the attenuator chip.

7. The apparatus of claim 4 wherein the different characteristic comprises a volume or a shape of a cavity coupled to a neck of the attenuator.

8. The apparatus of claim 1 wherein the attenuator chip comprises a top cap, a bottom cap and a wafer between the top cap and the bottom cap.

9. The apparatus of claim 8 further comprising a post between the top cap and the bottom cap.

10. The apparatus of claim 1 wherein the port comprises a number of holes.

11. The apparatus of claim 1 wherein the movable member comprises a plate operable to move in response to a wave of sound or a pressure change within the front chamber.

12. The apparatus of claim 1 wherein the MEMS chip comprises an actuator or a sensor.

13. The apparatus of claim 1 further comprising a package substrate coupled to the MEMS chip.

14. The apparatus of claim 13 wherein the package substrate comprises a cavity coupled to a neck of at least one attenuator of the array of attenuators.

15. The apparatus of claim 13 wherein the package substrate is coupled to a top side of the attenuator chip and a bottom side of the MEMS chip.

16. An apparatus comprising:
an attenuator chip comprising:
a wafer having a port extending from a top side to a bottom side of the wafer; and
an array of attenuators formed within the wafer and arranged around the port.

17. The apparatus of claim 16 wherein each attenuator of the array of attenuators comprises a neck having a first open end coupled to the port and a second open end coupled to a cavity formed within the wafer.

18. The apparatus of claim 16 wherein at least one attenuator of the array of attenuators comprises a different characteristic than another attenuator that is selected to attenuate different ultrasonic frequencies.

19. The apparatus of claim 16 wherein the attenuator chip comprises a first attenuator chip, and a second attenuator chip having an array of attenuators arranged around the port is coupled to the first attenuator chip.

20. The apparatus of claim 16 wherein the attenuator chip comprises a top cap, a bottom cap and a wafer between the top cap and the bottom cap.

21. The apparatus of claim 16 wherein the port comprises a cross shape.

22. The apparatus of claim 16 wherein the attenuator chip is coupled to a microelectromechanical systems (MEMS) chip having a movable member coupled to a front chamber, and the movable member comprises a plate operable to move in response to a wave of sound or a pressure change within the front chamber.
